(19) United States
(12) Patent Application Publication
(10) Pub. No.: US 2006/0112245 A1
(43) Pub. Date: May 25, 2006

(54) Storage system transfering volume information

(76) Inventors: Naoko Ikegaya, Sagamihara (JP); Hideaki Abe, Yokohama (JP); Kazuhiko Watanabe, Yokohama (JP); Masahide Sato, Noda (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/049,245

(22) Filed: Feb. 3, 2005

(30) Foreign Application Priority Data
Nov. 24, 2004 (JP) 2004-339234

(51) Int. Cl. G06F 12/14

(52) U.S. Cl. 711/163

(57) ABSTRACT

To set access limitation, which limits access to a remote volume, to each host computer separately without registering in advance information on which volume is accessible to which host computer. In the storage system, the storage system is coupled to other storage systems in multiple stages, the uppermost stage storage system is coupled to the host computer, the volume constitutes a remote copy pair with a volume in the lower stage storage system and/or a remote copy pair with a volume in the upper stage storage system, and upon receiving a command to operate the volume, a control unit refers to pair information stored in a memory to judge whether information of the lower stage volume paired with the volume in the storage system that has this control unit is added to the received command.

### CLAIM OF PRIORITY

The present application claims priority from Japanese application P2004-339234 filed on Nov. 24, 2004, the content of which is hereby incorporated by reference into this application.

### BACKGROUND

This invention relates to a storage system and more specifically a technique to control access to a volume set in a storage system.

Recent computer systems handle large-sized data and frequently update such data. An important object in storage technology is to develop a large-sized data backup method that ensures a quick recovery of a computer system from a failure to its normally functioning state.

One solution is remote copying (see JP 2004-13367 A, for example). In remote copying, data updated in one of remote storage sub systems (external storage systems), which have magnetic disk arrays and which are coupled to one another via communication paths, is automatically copied to another of the remote storage sub systems without sending the data through a host computer.

Another technique proposed prevents data leakage by an active copy command issued from a component inside a storage sub system (see JP 2003-242039 A, for example). This technique checks, prior to active data copy processing by a logical storage system, whether or not a computer is allowed to access this logical storage system from an association relation between the WWN of the computer and the logical device identifier LUN of the logical storage system. Whether access control is possible or not is judged for each logical storage system to which data is to be copied, as well as a logical storage system whose data is to be copied.

### SUMMARY

According to the conventional techniques disclosed in JP 2003-242039 A, it does not limit access to a storage volume that is not directly coupled to a host computer. In other words, the techniques disclosed in JP 2003-242039 A allows remote copying to change the state of paired volumes coupled to a host computer and other volumes as well, thereby enabling another host computer to break a remote volume to which data is being copied through remote copying by the former host computer.

Furthermore, information on which volume is accessible to which host computer has to be registered in advance in order to control access to remote volumes.

It is therefore an object of this invention to set access limitation, which limits access to a remote volume, to each host computer separately without registering in advance information on which volume is accessible to which host computer.

This embodiment of this invention relates to a storage system to store data to be used by a host computer, which includes: a disk array having a volume in which data is stored; a memory to store a management program; a control unit which controls the volume by executing the management program; and an input/output unit which exchanges a command with the host computer and with the storage system, in which: the storage system is coupled to other storage systems in multiple stages; the uppermost stage storage system is coupled to the host computer; the volume constitutes a remote copy pair with a volume in the lower stage storage system and/or a remote copy pair with a volume in the upper stage storage system; and upon receiving a command to operate the volume, the control unit refers to, pair information stored in the memory and judges whether information of the lower stage volume paired with the volume in the storage system that has this control unit is added to the received command.

A storage system according to an embodiment of this invention makes it possible to limit access to a storage system that is not directly coupled to a host computer.

### BRIEF DESCRIPTION OF THE DRAWINGS

The present invention can be appreciated by the description which follows in conjunction with the following figures, wherein:

FIG. 1 is a block diagram showing the configuration of a computer system according to an embodiment of this invention;

FIG. 2 is a conceptual diagram of the operation of the computer according to the embodiment of this invention;

FIG. 3 is a configuration diagram of a memory in a host computer according to the embodiment of this invention;

FIG. 4 is a configuration diagram of system configuration information according to the embodiment of this invention;

FIG. 5 is a configuration diagram of DKC connection information according to the embodiment of this invention;

FIG. 6 is a configuration diagram of a memory in a storage controller according to the embodiment of this invention;

FIG. 7 is a configuration diagram of pair information according to the embodiment of this invention;

FIG. 8 is a configuration diagram of a volume access control table according to the embodiment of this invention;

FIG. 9 is an explanatory diagram of a remote operation command according to the embodiment of this invention;

FIG. 10 is an explanatory diagram of accessible volume information according to the embodiment of this invention;

FIG. 11 is a flow chart of processing executed by a remote copy operation program according to the embodiment of this invention;

FIG. 12 is a flow chart of processing executed by a remote access possibility judging program according to the embodiment of this invention;

FIG. 13 is an explanatory diagram of a remote scan command according to the embodiment of this invention;

FIG. 14 is an explanatory diagram of volume information of another host according to the embodiment of this invention;

FIG. 15 is a flow chart of remote scan operation request processing according to the embodiment of this invention;

FIG. 16 is an explanatory diagram of a remote scan operation screen according to the embodiment of this invention;

FIG. 17 is an explanatory diagram of a remote scan result display screen according to the embodiment of this invention;

FIG. 18 is an explanatory diagram of another remote scan operation screen according to the embodiment of this invention;

FIG. 19 is an explanatory diagram of another remote scan result display screen according to the embodiment of this invention; and

FIG. 20 is a flow chart of remote scan processing according to the embodiment of this invention.

### DETAILED DESCRIPTION OF THE PREFERRED EMBODIMENT

An embodiment of this invention will be described below with reference to the accompanying drawings.

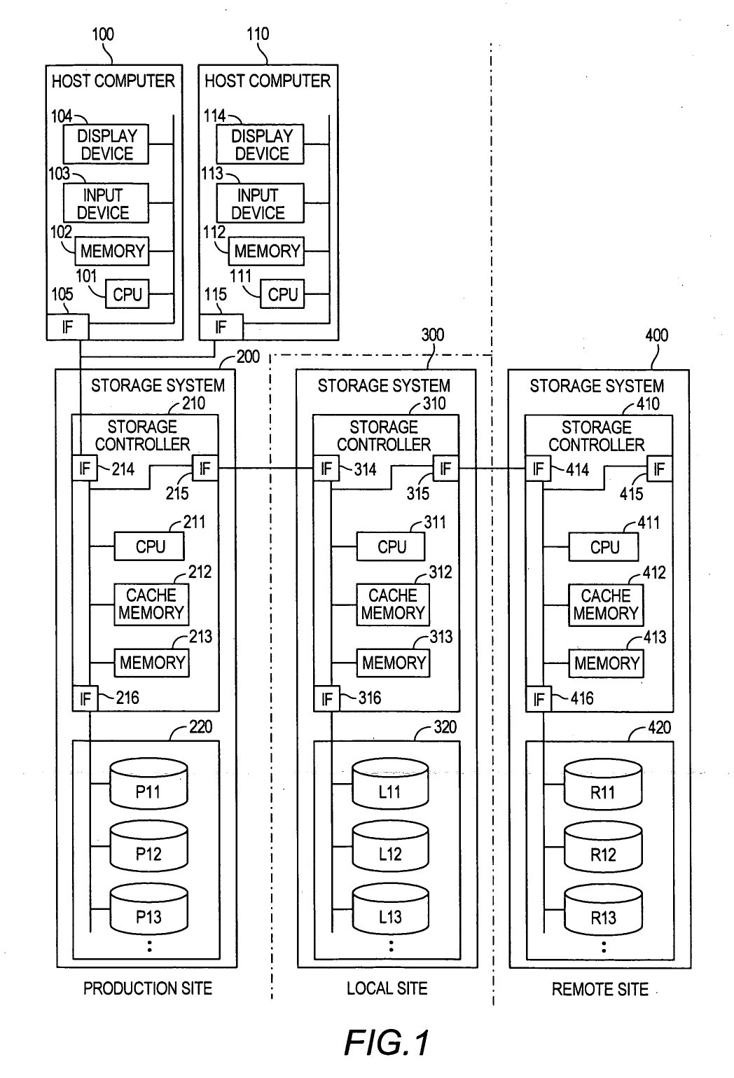

FIG. 1 is a block diagram showing the configuration of a computer system according to an embodiment of this invention.

The computer system of this embodiment is composed of host computers 100 and 110, and storage systems 200, 300, and 400.

The host computer 100 has a CPU 101, a memory 102, an input device 103, a display device 104, and an interface 105.

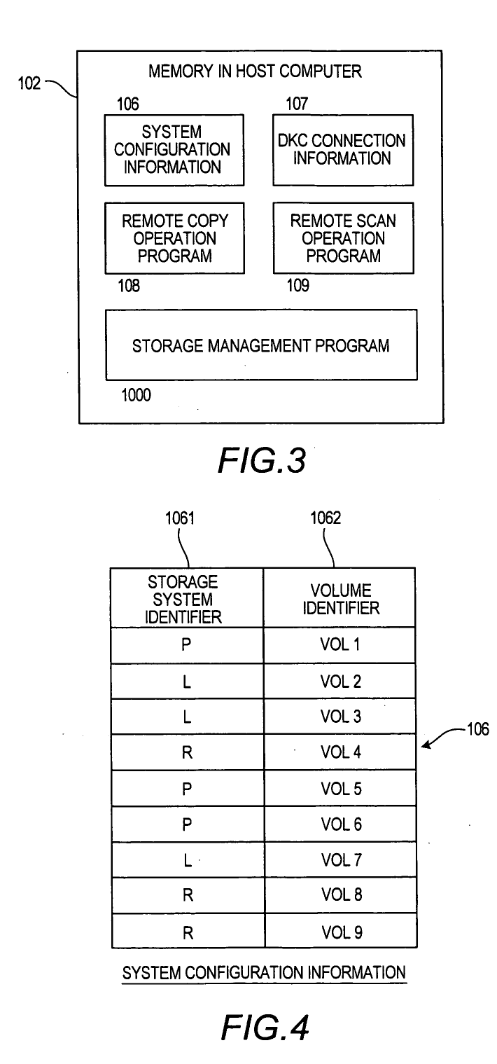

As shown in FIG. 3, system configuration information 106, DKC connection information 107, a remote copy operation program 108, a remote scan operation program 109 and a storage management program 1000 are stored in the memory 102 of the host computer 100.

Also stored in the memory 102 is an application program, which is executed by the CPU 101 to exchange data with the storage system 200.

The interface 105 couples the host computer 100 to the storage system 200 using a protocol that is suitable for data input and output.

The host computer 110 is similar to the host computer 100, and has a CPU 111, a memory 112, an input device 113, a display device 114 and an interface 115.

The storage system 200 has a storage controller 210 and a disk array 220. The storage controller 210 controls data inputted to and outputted from the disk array 220.

The storage controller 210 has a CPU 211, a cache memory 212, a memory 213, and interfaces 214, 215 and 216.

Stored in the memory 213 is a control program, which is executed by the CPU 211 to control data inputted to and outputted from the disk array 220 upon request from the host computer 100 or from other component. The cache memory 212 temporarily stores data inputted to and outputted from the disk array 220.

The interface 214 couples the storage system 200 to an upper level device (here, the host computer 100). The interface 215 couples the storage system 200 to a lower level device (here, the storage system 300). The interfaces 214 and 215 use a protocol suitable for data input and output to couple those devices with one another.

The interface 216 couples the storage controller 210 to the disk array 220 using the Fibre Channel protocol.

The disk array 220 has plural disk drives. The disk drives are controlled by the storage controller 210 and constitute a RAID.

The storage system 300 is similar to the storage system 200, and has a storage controller 310 and a disk array 320. The storage controller 310 is composed of a CPU 311, a cache memory 312, a memory 313, and interfaces 314, 315 and 316.

The storage system 400 has a storage controller 410 and a disk array 420. The storage controller 410 is composed of a CPU 411, a cache memory 412, a memory 413, and interfaces 414, 415 and 416.

The host computers 100 and 110 and the storage system 200 are located on a production site. The storage system 200 is coupled to the host computers 100 and 110. Data is inputted to and outputted from the storage system 200 when accessed by the host computers 100 and 110.

In other words, the production site has a storage system that is directly coupled to a host computer (host computers).

The storage system 300 is located on a local site. The storage system 300 is directly coupled to the storage system 200 but not to the host computers 100 and 110. In other words, the local site has a storage system that is directly coupled to none of host computers but is directly coupled to a storage system on the production site.

The storage system 300 receives data transferred from the storage system 200. Through this data transfer, data stored in the storage system 200 on the production site is copied to the storage system 300 on the local site.

The storage system 400 is located on a remote site. The storage system 400 is coupled to the storage system 300 on the local site and receives data transferred from the storage system 300. Through this data transfer, data stored in the storage system 300 on the local site is copied to the storage system 400 on the remote site.

In other words, the remote site has a storage system that is directly coupled to neither a host computer nor a storage system on the production site.

The production site, the local site, and the remote site are thus connected in stages by cascade connection via transmission paths for remote copying between the production site and the local site and for remote copying between the local site and the remote site. Desirably, volumes on the same transmission path have the same configuration. Volumes on different transmission paths may have different configurations.

Remote copying described above is divided into asynchronous copying and synchronous copying. This embodiment can employ either type of copying.

In a more desirable example, the local site is relatively near the production site. The local site and the production site may be provided in the same place. The storage system 300 on the local site receives data transferred by synchronous remote copying from the storage system 200 on the production site. Data stored in the storage system 200 on the production site is copied to the storage system 300 on the local site by synchronous copying in a relatively short time.

The remote site is in a place remote from the production site. The storage system 400 on the remote site receives data by asynchronous remote copying from the storage system 300 on the local site. Data stored in the storage system 300 on the local site is copied to the storage system 400 on the remote site by asynchronous remote copying in a relatively long time (longer than the time remote copying between the production site and the local site takes).

The remote site may have a second host computer in preparation for a large-scale failure.

The storage systems in the example shown in FIG. 1 are coupled in three stages by cascade connection via a single path, but the number of paths and the number of stages may be changed. It is also possible to vary the number of storage systems from one site to another.

The operation of the computer system according to this embodiment will be described next.

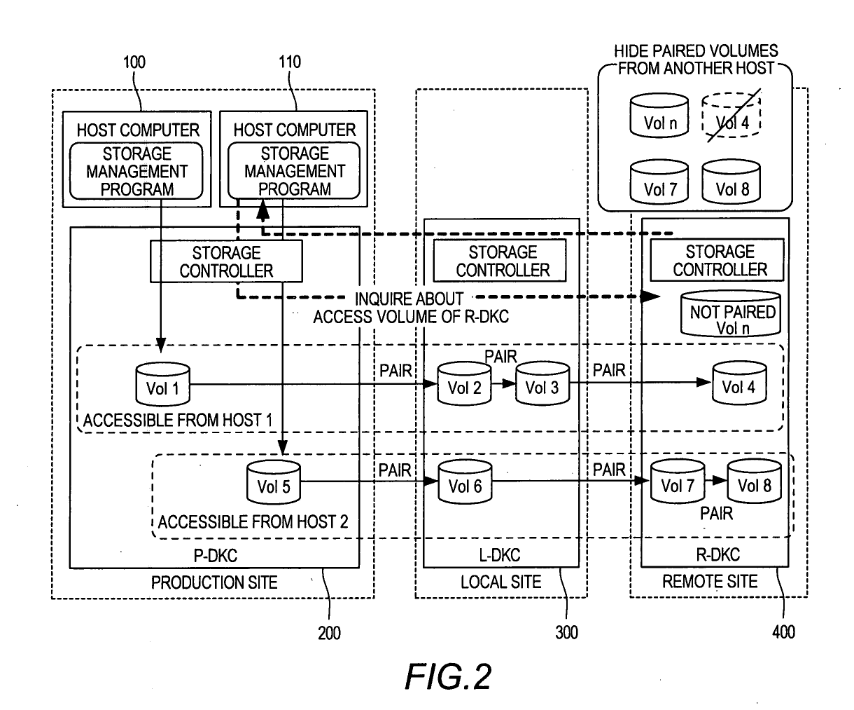

FIG. 2 is a conceptual diagram of the operation of the computer system according to this embodiment.

The application program of the host computer 100 accesses a volume 1 of the storage system (P-DKC) 200 on the production site which is accessible to the host computer 100. Upon access, data is inputted to and outputted from the volume 1. Data written in the volume 1 is transferred to the storage system (L-DKC) 300 on the local site to be written in a volume 2, which constitutes a remote copy pair with the volume 1. Similarly, data written in the volume 2 is written in a volume 3, which constitutes a remote copy pair with the volume 2. Data written in the volume 3 is transferred to the storage system (R-DKC) 400 on the remote site to be written in a volume 4, which constitutes a remote copy pair with the volume 3.

In this way, the same data as the one stored in the remote copy source volume (Volume 1) is stored in volumes that constitute remote copy pairs.

Similarly, the application program of the host computer 110 accesses a volume 5 which is accessible to the host computer 110. Upon access, data is inputted to and outputted from the volume 5. Data written in the volume 5 is also written in a volume 6, a volume 7 and a volume 8.

As in the above-described data transfer by remote copying, the remote copy operation program 108 of the host computer 100 accesses the volume 1, which is accessible to the host computer 1, to obtain configuration information of the volume 1. The remote copy operation program 108 of the host computer 100 also accesses the volume 2, which constitutes a pair with the volume 1, to obtain configuration information of the volume 2. Similarly, the remote copy operation program 108 of the host computer 100 accesses the volume 3 and the volume 4, which constitute a pair at a stage lower than the volume 1.

That is, the remote copy operation program 108 of the host computer 100 accesses volumes that constitute pairs at stages lower than the volume 1 to obtain configuration information of these volumes.

A remote copy operation program 118 of the host computer 110 accesses the volume 5, which is directly accessible to the host computer 110, and volumes (Volume 6 to Volume 8) that constitute pairs at stages lower than the volume 5 to obtain configuration information of these volumes.

The remote copy operation program 108 of the host computer 100 and the remote copy operation program 118 of the host computer 110 access a volume (Volume n) that is provided in the storage system on the remote site and that is not a part of any pair to obtain configuration information of this volume.

That is, the remote copy operation program 118 of the host computer 110 accesses a volume that is accessible to the host computer 110, volumes that constitute a pair at a stage lower than this volume, and a volume that is not paired with any volume to obtain configuration information of these volumes.

Taking the storage system on the remote site as a specific example, the remote copy operation program 118 is allowed to access volumes (Volume 7 and Volume 8) that constitute a pair at a stage lower than a volume that is accessible to the host computer 110, and a volume (Volume n) that is not paired with any volume while having no access to a volume (Vol4) that constitutes a pair at a stage lower than a volume that is accessible to the host computer 100.

In order to access a volume, a remote operation command is written in a storage controller that controls this volume to be operated.

In particular, a remote operation command issued by a remote copy operation program is written in the storage controller on the production site, and the written remote operation command is transferred to the storage controller on the local site and then to the storage controller on the remote site. The storage system on each site reads the remote operation command written in its storage controller, and is controlled according to the command.

This embodiment includes to check, before a remote operation command is issued to operate a volume that is not directly coupled to a host computer, whether or not this volume constitutes a pair at a stage lower than a volume that is accessible to a host computer from which the remote operation command is issued.

When this volume is paired with an accessible volume of the P-DKC, the remote operation command can be issued without any modification.

On the other hand, when this volume is not paired with an accessible volume of the P-DKC, identification information of a volume that is paired with an accessible volume of the P-DKC (accessible volume information 605) is added to the remote operation command that is to be transferred to the L-DKC. The L-DKC checks whether or not this volume to be operated is paired with an accessible volume of the P-DKC and judges this volume as an accessible volume only when this volume is a paired volume. In short, a host computer is not allowed to operate an L-DKC volume that does not constitute a pair with accessible volume of P-DKC, and an error message is sent to the host computer that has issued the operation command.

A remote operation command to operate a volume of the R-DKC can be issued without any modification when this volume is paired with an accessible volume of the L-DKC.

On the other hand, when this volume is not paired with an accessible volume of the L-DKC, identification information of a volume that is paired with an accessible volume of the L-DKC (accessible volume information 605) is added to the remote operation command that is to be transferred to the R-DKC. The R-DKC checks whether or not this volume to be operated is paired with an accessible volume of the L-DKC and judges this volume as an accessible volume only when this volume is a paired volume. In short, a host computer is not allowed to operate an R-DKC volume that does not constitute a pair with accessible volume of P-DKC, and an error message is sent to the host computer that has issued the operation command.

FIG. 3 is a configuration diagram of the memory 102 in the host computer 100.

Stored in the memory 102 are the system configuration information 106, the DKC connection information 107, the remote copy operation program 108, the remote scan operation program 109 and the storage management program 1000. The remote copy operation program 108, the remote scan operation program 109 and the storage management program 1000 are executed by the CPU 101. The host computer 100 manages the storage systems 200, 300 and 400 using these programs. The memory 112 of the host computer 110 stores the same information and the same programs as those stored in the memory 102.

The system configuration information 106 contains the association between a storage system and a volume as shown in FIG. 4. The system configuration information 106 is collected by executing the remote scan program 109.

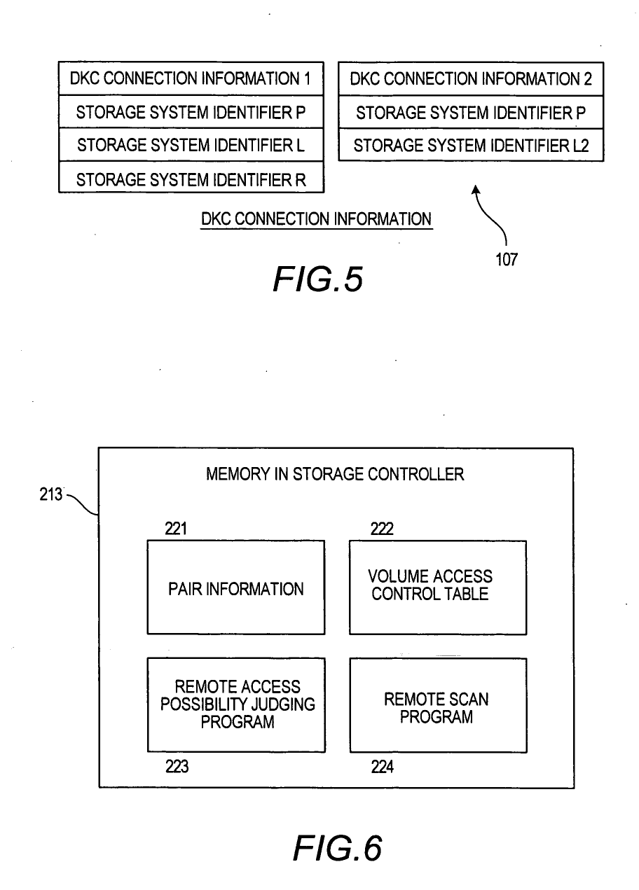

The DKC connection information 107 holds the order of coupling the storage systems as shown in FIG. 5.

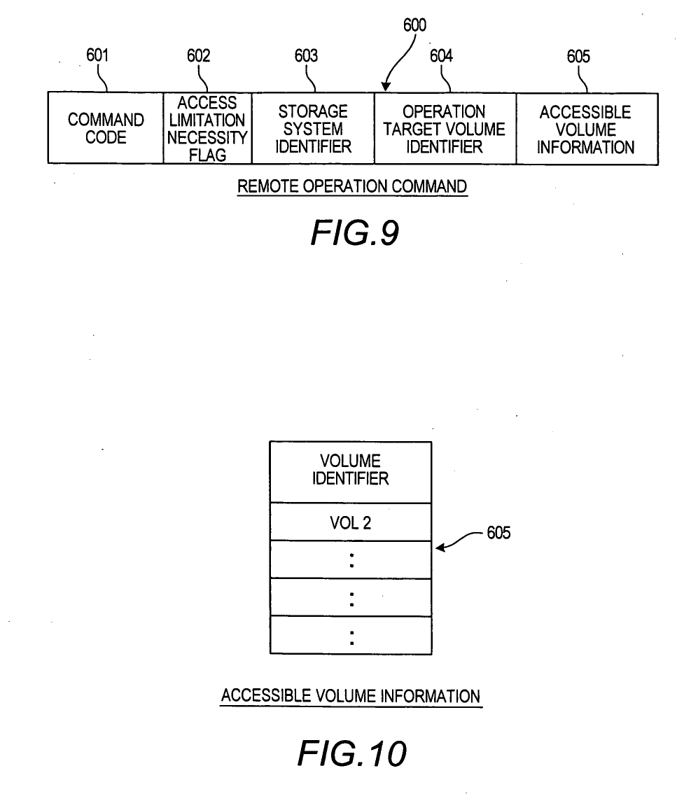

The remote copy operation program 108 issues a remote operation command 600, which will be described later with reference to FIG. 9.

The remote scan operation program 109 collects the system configuration information 106, which will be described later with reference to FIG. 4.

The storage management program 1000 manages a storage configuration and detects a storage failure.

FIG. 4 is a configuration diagram of the system configuration information 106 according to this embodiment.

The system configuration information 106 contains the association between a storage system identifier 1061 and a volume identifier 1062.

The volume identifier 1062 is an identifier unique to a volume provided in a storage system of a computer system.

The storage system identifier 1061 shows in which storage system (site) the volume identified by the identifier 1061 is placed. In particular, “P” represents the production site storage system which is directly coupled to a host computer, “L” represents the local site storage system which is directly coupled to the production site, and “R” represents the remote site storage system. The remote site storage system is directly coupled to neither a host computer nor the production site storage system.

FIG. 5 is a configuration diagram of the DKC connection information 107 according to this embodiment.

DKC connection information contains the order of coupling the storage systems.

For example, DKC connection information 1 shows that the production site storage system (the storage system identifier is P) is coupled to the local site storage system (the storage system identifier is L) and then to the remote site storage system (the storage system identifier is R).

The production site storage system (the storage system identifier is P) may be coupled to a second local site storage system (a storage system identifier is L2) as shown in DKC connection information 2. In this case, the production site storage system (P) is coupled to the local site storage system (L) and the second local site storage system (L2) both, branching the path. The connection between the production site storage system (P) and the second local site storage system (L2) is omitted from FIG. 1 and FIG. 2.

FIG. 6 is a configuration diagram of the memory 213 in the storage controller 210 according to this embodiment.

The memory 213 stores pair information 221, a volume access control table 222, a remote access possibility judging program 223 and a remote scan program 224. The remote access possibility judging program 223 and the remote scan program 224 are executed by the CPU 211. The memory 313 of the storage system 300 and the memory 413 of the storage system 400 store the same information and the same programs as those stored in the memory 213.

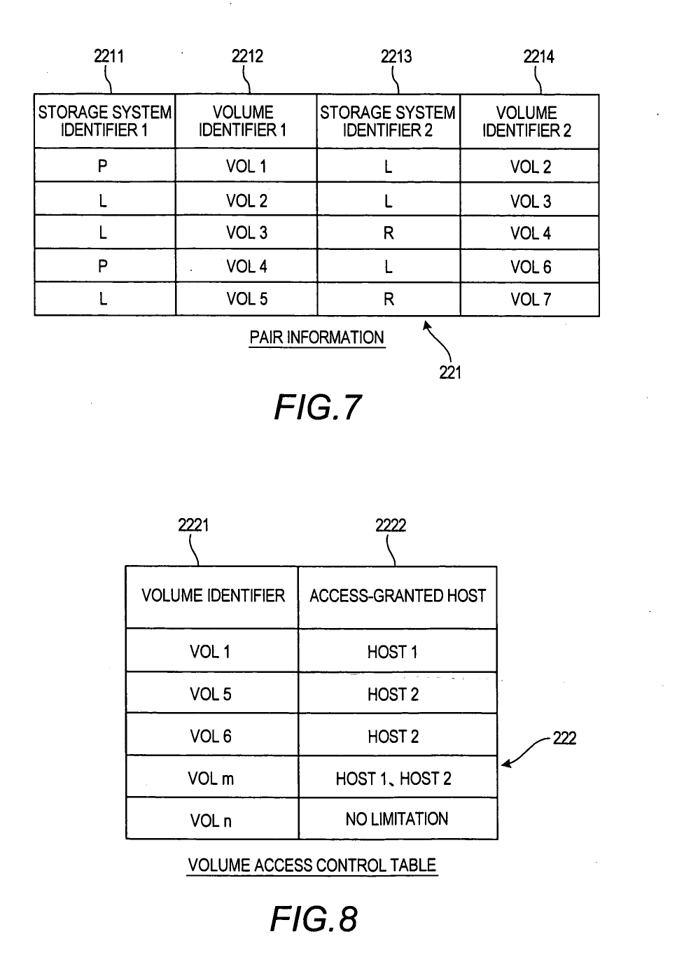

The pair information 221 stores the association between a volume in a storage system and a volume that constitutes a remote copy pair with the former volume as shown in FIG. 7.

The volume access control table 222 stores information of which host computer can access which volume in this storage system as shown in FIG. 8. The volume access control table 222 is provided only in the storage system 200 (the production site storage system), which is directly coupled to the host computer 100 and to other components.

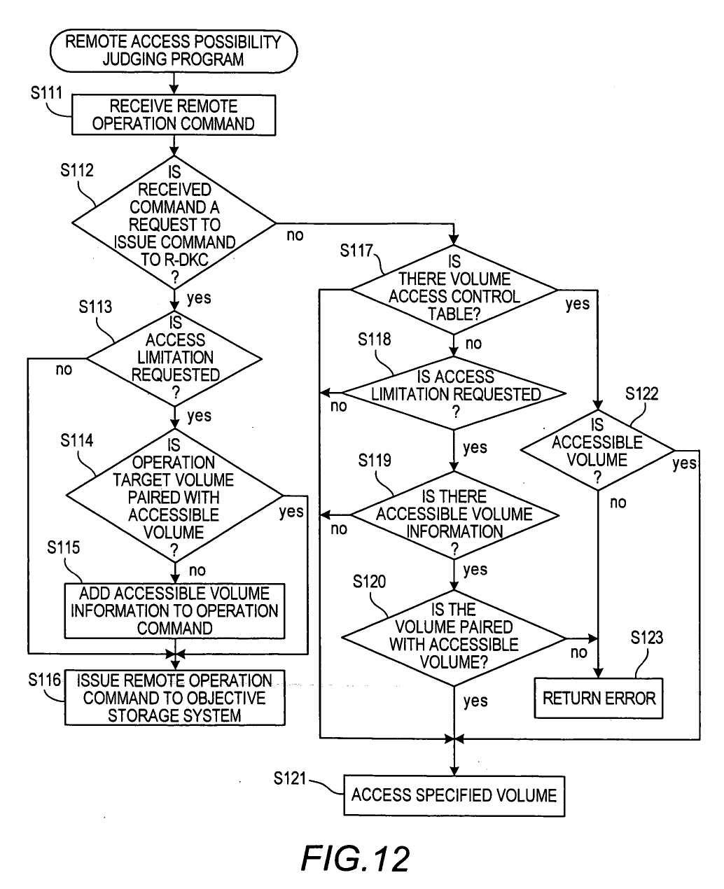

The remote access possibility judging program 223 processes the received remote operation command 600 as shown in FIG. 12.

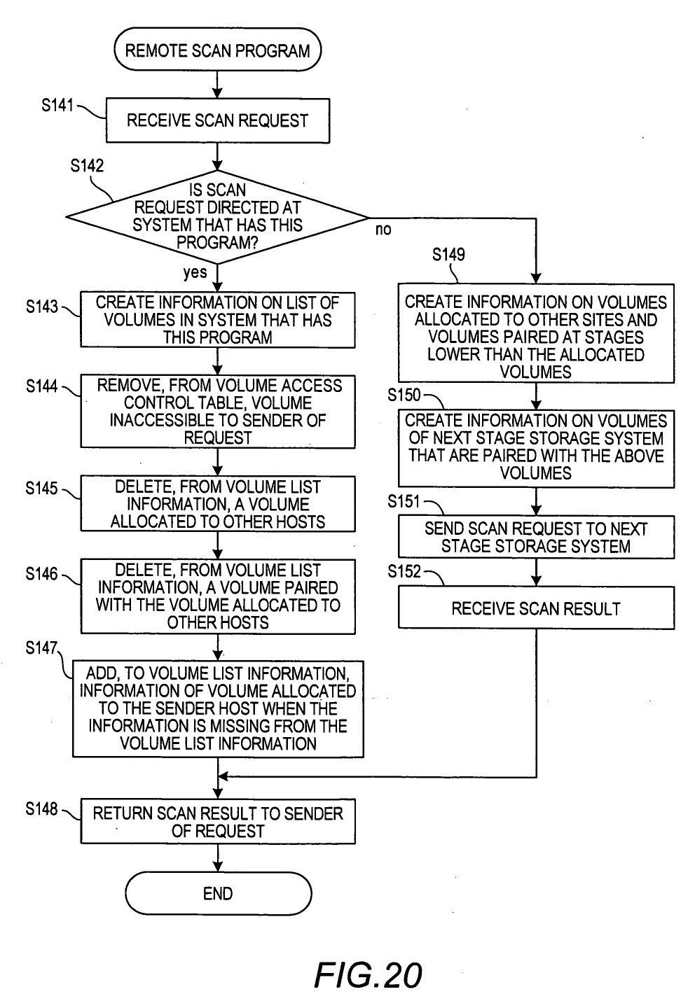

The remote scan program 224 collects information of a volume in a storage system to provide the system configuration information 106 as shown in FIG. 20.

FIG. 7 is a configuration diagram of the pair information 221 according to this embodiment.

The pair information 221 determines which volume is paired with which volume. The pair information 221 contains a storage system identifier 1 (2211), a volume identifier 1 (2212), a storage system identifier 2 (2213) and a volume identifier 2 (2214).

Each entry of the pair information 221 shows volumes constituting a remote copy pair. In particular, a volume having the volume identifier 1 is paired with a volume having the volume identifier 2.

The storage system identifier 1 is the identifier of the storage system in which the volume having the volume identifier 1 is placed. The storage system identifier 2 is the identifier of the storage system in which the volume having the volume identifier 2 is placed.

As has been described, remote copying is divided into synchronous remote copying and asynchronous remote copying. The type of remote copying may be recorded in the pair information 221.

FIG. 8 is a configuration diagram of the volume access control table 222 according to this embodiment.

The volume access control table 222 contains a volume identifier 2221 and an access-granted host computer 2222.

The volume identifier 2221 is an identifier unique to each volume, and is equal to the volume identifier 1062 in the system configuration information 106.

The access-granted host computer 2222 shows a host computer that is allowed to access the volume identified by the volume identifier 2221. As the table 222 shows, a host computer has access to a volume paired with a production site volume that is accessible to the host computer, and access to a lower-stage volume that constitutes a pair with the volume paired with the production site volume.

FIG. 9 is an explanatory diagram of the remote operation command 600 according to this embodiment.

The remote operation command 600 contains a command code 601, an access control necessity flag 602, a storage system identifier 603, an operation target volume identifier 604 and accessible volume information 605.

The command code 601 shows what type of control is to be exerted by the remote operation command 600.

The access limitation necessity flag 602 indicates whether access to the volume to be operated according to the remote operation command 600 should be limited or not. When the access limitation necessity flag 602 is set to “unnecessary”, the remote operation command is executed to operate the target volume irrespective of a volume access limitation set to the storage system.

The storage system identifier 603 shows in which storage system the volume to be operated according to the remote operation command 600 is placed.

The operation target volume identifier 604 indicates a volume to be operated according to the remote operation command 600.

The accessible volume information 605 indicates, as shown in FIG. 10, which volume out of volumes in the storage system identified by the identifier 603 is accessible to a host computer that has issued the remote operation command 600. The accessible volume information 605 is not included in a remote operation command when the remote operation command is issued from a host computer, and is added when a storage system transfers the received command to the lower stage storage system.

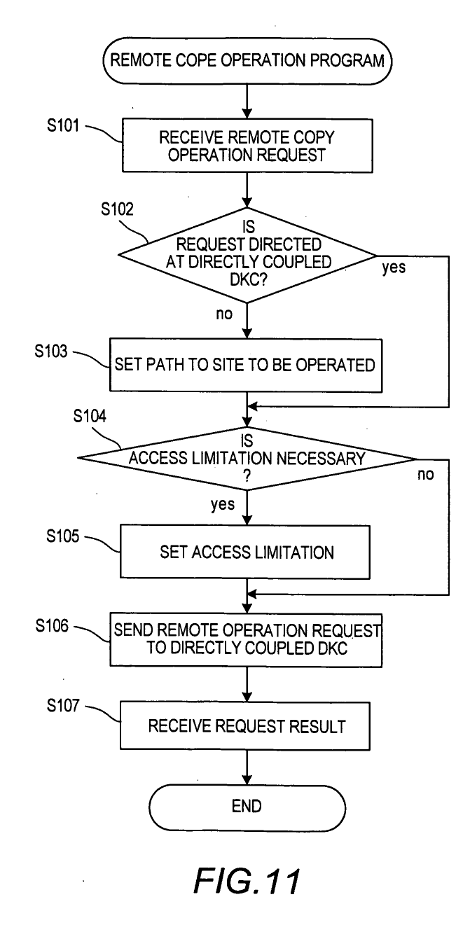

FIG. 11 is a flow chart of processing executed by the remote copy operation program 108 according to this embodiment.

The host computer 100 receives a remote copy operation request inputted by a user (S101). Receiving the request, the host computer 100 identifies a site to be operated and a volume to be operated. The identified operation target site is referred to judge whether or not the requested operation is directed at a storage system that is directly coupled to the host computer 100.

When it is judged as a result that the requested operation is directed at a storage system that is not directly coupled to the host computer 100 (namely, the storage systems L-DKC and R-DKC), the DKC connection information 107 is referred to specify an access path to the storage system to be operated (S103). The processing then proceeds to a step S104.

On the other hand, when it is judged that the requested operation is directed at the storage system (P-DKC) 200, which is directly coupled to the host computer 100, there is no need to specify an access path and the processing proceeds to the step S104.

In the step S104, whether the operation according to the remote operation command calls for access limitation or not is judged based on the user input (S104). What kind of access limitation is to be set is varied depending on the type of operation the command dictates. Conditions such as one which allows the host computer to refer to configuration information of a volume but prevents the host computer from changing the configuration of the volume and one which prohibits pairing volumes are set in advance, so that whether access limitation is necessary or not can be judged from the user input received in the step S101.

When access limitation is necessary, the access limitation necessity flag 602 is set (S105).

Thereafter, the remote copy operation request (remote copy operation command) is sent to the storage system (P-DKC) 200, which is directly coupled to the host computer 100 (S106).

Then the result of the remote operation command is received (S107). And then, the processing is ended.

FIG. 12 is a flow chart of processing executed by the remote access possibility judging program 223.

First, a remote operation command is received from a host computer (S111). At this point, the host computer that has sent the request (remote operation command) is identified from which interface has received the request. Alternatively, the host computer that has sent the request may be identified from a host identifier contained as a part of the communication data.

Thereafter, whether the received remote operation command is a request to issue a command directed at other storage systems than the one that has this program 223 or not is judged from a volume that is to be operated according to the received remote operation command (S112). When it is judged in the step S112 that the remote operation command is directed at another storage system, the processing proceeds to a step S113. When it is judged in the step S112 that the remote operation command is directed at the storage system that has this program 223, on the other hand, the processing proceeds to a step S117.

When it is judged in the step S112 that the remote operation command is directed at another storage system, the access limitation necessity flag 602 contained in the received remote operation command is referred to judge whether access limitation is requested or not (S113).

When access limitation is not requested, the processing proceeds to a step S116, where the remote operation command is issued to the other operation target storage system.

On the other hand, when access limitation is requested, the program 223 judges whether or not the operation target volume is paired with an accessible volume of the storage system that has this program 223 (S114).

When it is judged as a result that the operation target volume is paired with an accessible volume of the storage system that has this program 223, the processing proceeds to the step S116, where the remote operation command is issued to the other operation target storage system.

When the operation target volume is not paired with an accessible volume of the storage system that has this program 223, information of a volume paired with an accessible volume of the storage system that has this program 223 (the accessible volume information 605) is added to the remote operation command (S115). Then the remote operation command is issued to the other operation target storage system (S116).

When it is judged in the step S112 that the remote operation command is directed at the storage system that has this program 223, whether the volume access control table 222 is stored in the memory or not is judged (S117).

When the memory does not store the volume access control table 222, it is judged that the storage system that has this program 223 is not the production site storage system and the processing proceeds to a step S118. On the other hand, when the memory stores the volume access control table 222, the storage system that has this program 223 is judged as the production site storage system and the processing proceeds to a step S122.

When it is judged in the step S117 that the storage system that has this program 223 is not the production site storage system, the access limitation necessity flag 602 contained in the received remote operation command is referred to judge whether access limitation is requested or not (S113).

When access limitation is not requested, the operation target volume is accessible and the processing proceeds to a step S121, where the operation target volume is accessed.

When access limitation is requested, on the other hand, access to the operation target volume may be limited and accordingly whether the accessible volume information 605 is contained in the received remote operation command or not is judged (S119).

When the accessible volume information 605 is not contained in the received command, the operation target volume is accessible and the processing proceeds to the step S121, where the operation target volume is accessed.

When the accessible volume information 605 is contained in the received command, the accessible volume information 605 and the pair information 221 are referred to judge whether access to the operation target volume is limited or not (S120).

When access to the operation target volume is not limited, the operation target volume is accessible and the processing proceeds to the step S121, where the operation target volume is accessed. On the other hand, when access to the operation target volume is limited, access to this volume is not permitted and the processing proceeds to a step S123, where an error message is sent to the host computer that has issued the remote operation command.

When it is judged in the step S117 that the storage system that has this program 223 is the production site storage system, the volume access control table 222 is referred to judge whether the host computer that has sent the remote operation command should be granted access to the operation target volume or not (S122).

When this host computer is allowed to access the operation target volume as a result, the processing proceeds to the step S121, where the operation target volume is accessed by this host computer. On the other hand, when this host computer is not to be granted access to the operation target volume, the processing proceeds to the step S123, where an error message is sent to the host computer that has issued the remote operation command.

As has been described with reference to FIG. 12, accessible volume information is sent, along with a remote operation command, from one storage system to another storage system. Thus the right to control access to a volume is handed from one storage system to another and the burden of volume access control processing is decentralized.

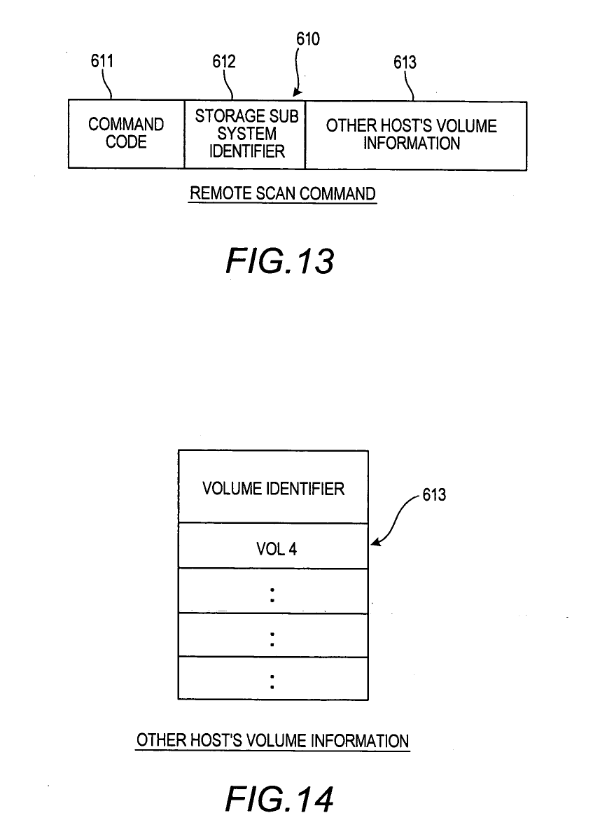

FIG. 13 is an explanatory diagram of a remote scan command according to this embodiment.

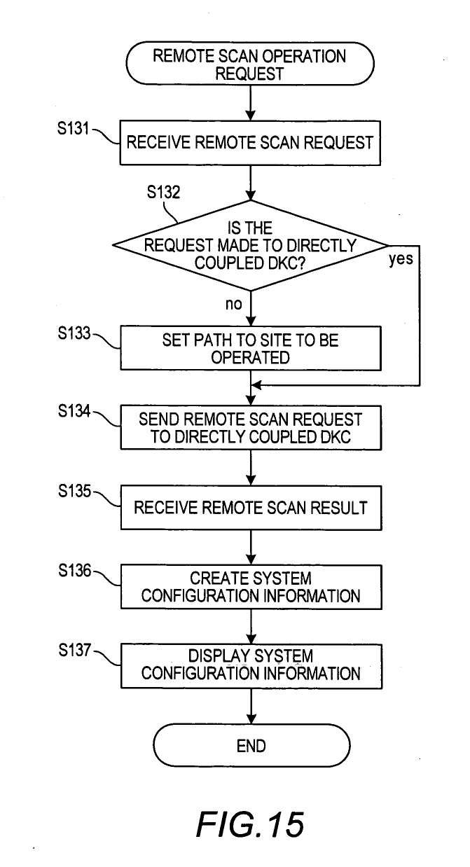

A remote scan command 610 is issued through remote scan processing shown in FIG. 15 to collect the system configuration information 106 shown in FIG. 4.

The remote scan command 610 contains a command code 611, a storage system identifier 612 and other host's volume information 613.

The command code 611 shows what type of control is to be exerted by the remote scan command 610.

The storage system identifier 612 indicates a storage system to be operated according to the remote scan command 610.

The other host's volume information 613 indicates, as shown in FIG. 14, which one of volumes in the relevant storage system is controlled by another host computer.

FIG. 15 is a flow chart of processing executed by the remote scan operation program 109 according to this embodiment. Through this remote scan processing, the system configuration information 106 is collected.

The host computer 100 receives a remote scan request inputted by a user (S131). Every remote scan request is accompanied with access limitation since remote scan request involves obtaining information on the storage systems.

Whether the inputted remote scan request is directed at the storage system that is directly coupled to the host computer 100 or not is judged next (S132).

When the remote scan request is directed at a storage system that is not directly coupled to the host computer 100 (the storage system L-DKC or R-DKC), the DKC connection information 107 is referred to specify an access path to the storage system to be scanned (S133). Then the processing proceeds to a step S134.

When the remote scan request is directed at the storage system (P-DKC) 200, which is directly coupled to the host computer 100, there is no need to specify an access path and the processing proceeds to the step S134.

In the step S134, the remote scan request (remote scan command) is sent to the storage system (P-DKC) 200, which is directly coupled to the host computer 100.

Then the result of the remote scan is received (S135) and, based on the received scan result, a site where a storage system having a volume is placed is identified to create the system configuration information 106 (S136). The created system configuration information 106 is displayed (S137).

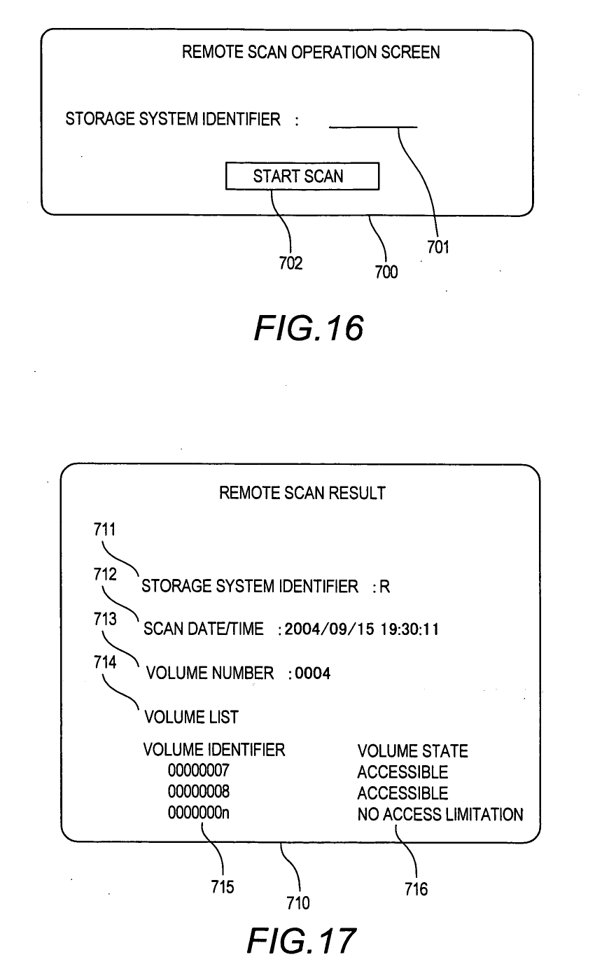

FIG. 16 is an explanatory diagram of a remote scan operation screen according to this embodiment.

A remote scan operation screen 700 has a storage system identifier entering field 701 and a start scan button 702. A user enters, in the storage system identifier entering field 701, the identifier of a storage system on which a remote scan is to be performed and then clicks on the start scan button 702 to start up the remote scan operation program 109 and obtain system configuration information of the storage system that has the identifier entered on this screen.

System configuration information of plural storage systems may be obtained at the same time by entering identifiers of the plural storage systems in the storage system identifier entering field 701.

FIG. 17 is an explanatory diagram of a remote scan result display screen according to this embodiment.

A remote scan result display screen 710 has a storage system identifier display field 711, a scan date/time display field 712, a volume number display field 713 and a volume list display field 714. The volume list display field 714 includes a volume identifier 715 and a volume state 716.

The storage system identifier display field 711 is for displaying the identifier of a storage system whose system configuration information is obtained by a remote scan.

The scan date/time display field 712 is for displaying the date and time when the system configuration information is obtained by the remote scan.

The volume number display field 713 is for displaying the number of volumes in the storage system on which the remote scan is performed.

The volume identifier 715 is the identifier of a volume in the storage system on which the remote scan is performed.

The volume state 716 indicates the state of the volume that is identified by the volume identifier 715.

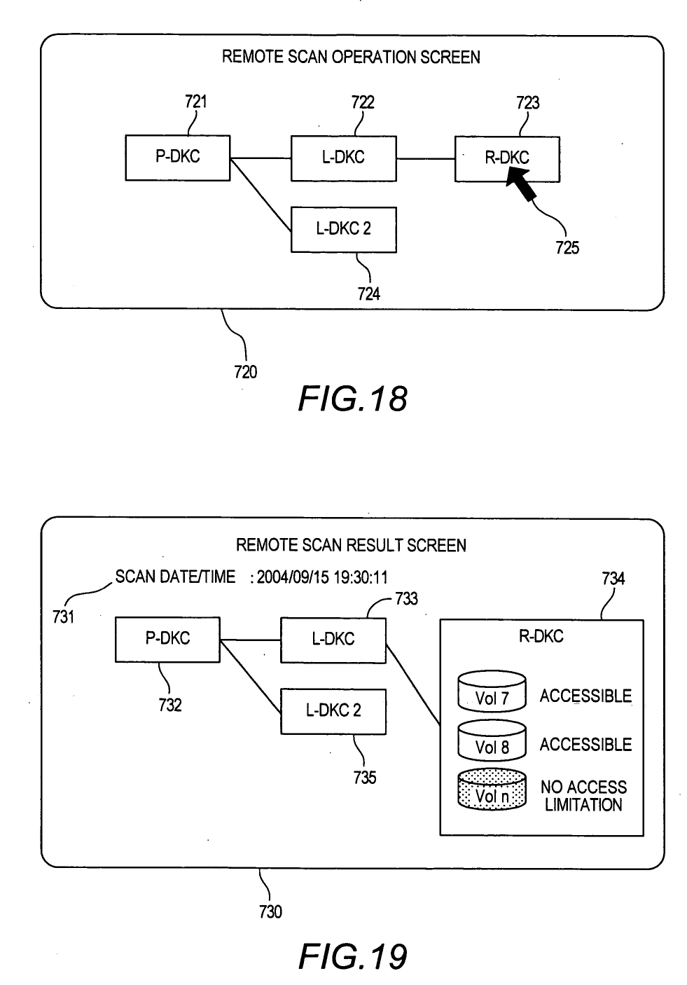

FIG. 18 is an explanatory diagram of another remote scan operation screen according to this embodiment.

A remote scan operation screen 720 displays storage system identifiers 721 to 724 in a manner that reflects the way the storage systems are coupled to one another. How the storage systems are coupled to one another is specified by the DKC connection information 107.

A user chooses, from the storage systems displayed on the screen, one on which a remote scan is to be performed. This starts up the remote scan operation program 109 and system configuration information of the storage system selected is obtained.

FIG. 19 is an explanatory diagram of another remote scan result display screen according to this embodiment.

A remote scan result display screen 730 has a scan date/time display field 731, storage system identifiers 732, 733, and 735, and volume information 734.

The scan date/time display field 731 is for displaying the date and time when system configuration information is obtained by a remote scan.

As is the remote scan operation screen 720, the remote scan result display screen 730 displays the storage system identifiers in a manner that reflects the way the storage systems are coupled to one another.

The volume information 734 is information of volumes set in the storage system on which the remote scan is performed, and is displayed where the scanned storage system is displayed on the screen 730.

Displayed as the volume information 734 are a volume identifier and a volume attribute. The volume attribute indicates whether this volume is accessible to a host computer or not. To elaborate, “accessible” is displayed as the volume attribute when the volume is accessible to a host computer that has requested the remote scan and “no access limitation” is displayed as the volume attribute when the volume is accessible to any host without limitation.

Volumes in the volume information 734 may be displayed in varying forms (shapes, colors, or the like) to reflect different volume attributes.

FIG. 20 is a flow chart of processing executed by the remote scan program 224 according to this embodiment. This remote scan processing provides a host computer with the system configuration information 106.

First, a remote scan command is received from a host computer (S141). At this point, the host computer that has sent the request (remote scan command) is identified from which interface has received the request. Alternatively, the host computer that has sent the request may be identified from a host identifier contained as a part of the communication data.

Thereafter, whether the received remote scan command is a request made to the storage system that has this program 224 or not is judged from a volume that is to be scanned according to the received remote scan command (S142). When it is judged as a result that the remote scan command is directed at the storage system that has this program 224, the processing proceeds to a step S143. When it is judged as a result that the remote scan command is directed at other storage systems than the one that has this program 224, on the other hand, the processing proceeds to a step S149.

When it is judged in the step S142 that the remote scan command is directed at the storage system that has this program 224, list information is created which lists every volume in this storage system (S143). In other words, the volume list information created at this point contains the identifier of every volume in this storage system.

Judged next is whether the volume access control table 222 is stored in the memory of the storage system that has this program 224 or not. When the memory stores the volume access control table 222 (meaning that this storage system is the production site storage system), a volume accessible to other host computers than the one that has made the remote scan request is removed from the volume access control table 222 (S144).

Then the other host's volume information 613 is referred to delete information of a volume paired with a volume that is controlled by other host computers (S145).

The pair information 221 is referred to delete information of a volume, out of volumes in the storage system that has this program 224, that is paired with the volume deleted in the step S145 (S146).

Volume information is deleted in the steps S145 and S146 since paired volumes that are controlled by other host computers use the other host's volume information 613. In the case where one volume is allocated to and shared among plural host computers, information of this volume is not deleted.

Then the volume access control table 222 is referred. Out of volumes in the storage system that has this program 224, information of a volume allocated to the host computer that has made the remote scan request is added when this information is not found in the table 222 (S147).

Created through the above processing is volume list information which lists, of volumes in the storage system that has this program 224, those that are accessible to the host computer and those that constitute remote copy pairs with the volumes accessible to the host computer.

The created volume list information can contain a common volume allocated to plural host computers since information of a volume allocated to the host computer that has requested to obtain information is added to the volume list information.

Then the created volume list information is sent as a scan result to the host computer that has made the remote scan request (S148).

When it is judged in the step S142 that the remote scan command is directed at other storage systems than the storage system that has this program 224, pair information is created for, out of volumes in the storage system that has this program 224, those that are paired with volumes allocated to the other storage systems (sites) in step S149.

The pair information 221 is then referred to create pair volume information about volumes in the lower stage storage system that are paired with the paired volumes specified in the step S149 (S150).

The scan request is sent to the lower stage storage system (S151). A scan result is received (S152) and the received scan result is sent to the host computer that has made the scan request (S148).

As has been described, this embodiment can set access limitation, which limits access to storage systems that are indirectly coupled to a host computer (the local site storage system and the remote site storage system), to each host computer separately. This embodiment is therefore capable of preventing one host computer from unintentionally breaking a volume that is being used by another host computer.

It is also possible to set access limitation to each host computer separately by determining in advance which one of volumes in the storage system that is directly coupled to a host computer (the storage system P-DKC) is accessible and which one is not. In this case, there is no need to determine which one of volumes in the other storage systems than P-DKC is accessible and which one is not. Thus access control adaptable to a change in pair configuration is provided.

This invention is not limited to the embodiment described above, and is also applicable to an open system computer system, for example. In an application to an open system, the interface 105 of the storage system couples the storage system to a management computer which manages host computers or components of the computer system with the use of a protocol that is suitable to transfer a volume operation command, such as FC-SAN, IP-SAN, or LAN. Therefore, when a host computer or the management computer issues an operation command to operate volumes, access control through other storage systems can be set for each volume separately.

While the present invention has been described in detail and pictorially in the accompanying drawings, the present invention is not limited to such detail but covers various obvious modifications and equivalent arrangements, which fall within the purview of the appended claims.

What is claimed is:

1. A storage system to store data, comprising:
plurality of disk drives configured into at least one volume in which data is stored;
a memory;
a control unit which manages the volume; and
an input/output unit which transfers a command with a host computer and with the storage system,
wherein the storage system is coupled to other storage systems by cascade connection forming multiple stages,
wherein the uppermost stage storage system is coupled to the host computer,
wherein the volume constitutes a remote copy pair with a volume in the lower stage storage system and/or a remote copy pair with a volume in the upper stage storage system, and
wherein upon receiving a command to operate the volume, the control unit refers to pair information stored in the memory and judges whether information of the lower stage volume paired with the volume in the storage system that has this control unit is added to the received command.

2. The storage system according to claim 1,
wherein the control unit adds, to the received command, the information of the lower stage volume paired with the volume in the storage system that has this control unit when the volume to be operated according to the command is not paired with the volume in the storage system that has this control unit, and
wherein the control unit transfers the command to the lower stage storage system without adding any information to the received command when the volume to be operated according to the command is paired with the volume in the storage system that has this control unit.

3. The storage system according to claim 1,
wherein the storage system stores information about which volumes in the storage system,
wherein the control unit judges that the host computer has issued the received command when the information about which one of volumes is accessible or not from the host computer, and
wherein the control unit refers to accessibility information of this volume and judges whether access to the volume to be operated according to the command is limited.

4. The storage system according to claim 1,
wherein the storage system stores information about which volumes in the storage system,
wherein the control unit judges that the host computer has issued the received command when the information about which one of volumes is accessible or not from the host computer.

5. The storage system according to claim 4,
wherein, when the information of the next stage volume that is paired with one of the volumes in this storage system, the control unit permits access to the volume to be operated according to the received command and
wherein, when the information of the next stage volume that is paired with one of the volumes in this storage system, the control unit refers to the received information and the pair information and judges whether access to the volume to be operated according to the command should be limited.

6. A computer system, comprising plural storage systems coupled to one another in multiple stages, and a host computer coupled to uppermost one of the stage storage systems, the storage systems comprising
plurality of disk drives configured into at least one volume in which data is stored,
a memory,
a control unit which manages the volume, and
an input/output unit which transfers a command with the host computer and with the storage system,
the volume in the storage system constituting a remote copy pair with a volume in the lower stage storage system and/or a remote copy pair with a volume in the upper stage storage system, and
wherein upon receiving a command to operate the volume, the control unit refers to pair information stored in the memory and judges whether information of the lower stage volume paired with the volume in the storage system that has this control unit is added to the received command.

7. The computer system according to claim 6,
wherein the control unit adds, to the received command, the information of the lower stage volume paired with the volume in the storage system that has this control unit when the volume to be operated according to the command is not paired with the volume in the storage system that has this control unit, and
wherein the control unit transfers the command to the lower stage storage system without adding any information to the received command when the volume to be operated according to the command is paired with the volume in the storage system that has this control unit.

8. The computer system according to claim 6,
wherein the storage system stores information about which volumes in the storage system,
wherein the control unit judges that the host computer has issued the received command when the information about which one of volumes is accessible or not from the host computer, and
wherein the control unit refers to accessibility information of this volume and judges whether access to the volume to be operated according to the command is limited.

9. The computer system according to claim 6,
wherein the storage system stores information about which volumes in the storage system,
wherein the control unit judges that the host computer has issued the received command when the information about which one of volumes is accessible or not from the host computer.

10. The computer system according to claim 9,
wherein, when the information of the next stage volume that is paired with one of the volumes in this storage system, the control unit permits access to the volume to be operated according to the received command and
wherein, when the information of the next stage volume that is paired with one of the volumes in this storage system, the control unit refers to the received information and the pair information and judges whether access to the volume to be operated according to the command should be limited.

11. A storage system information obtaining method for use in a computer system comprising plural storage systems coupled to one another in multiple stages, and a host computer coupled to uppermost one of the stage storage systems, a disk drive including volumes, the volume in the storage system constituting a remote copy pair with a volume in the lower stage storage system and/or a remote copy pair with a volume in the upper stage storage system, the method comprising:
determining a volume accessible from the host computer among the volumes in the storage system that is coupled directly to the host computer;
determining volumes constituting remote copy pairs at lower stages;
obtaining information of a volume related to the volume accessible to the host computer; and
displaying the obtained volume.

12. The information obtaining method according to claim 11 further comprising, deleting information of the volume allocated to other host computers than the one that has made an information obtaining request, and information of the volume paired with the allocated volumes, from the obtained volume information.

13. The information obtaining method according to claim 11 further comprising, adding information of the information of the volume allocated to the host computer that has made an information obtaining request, to the obtained volume information.
